(19) United States
(12) Patent Application Publication
(10) Pub. No.: US 2018/0262473 A1
(43) Pub. Date: Sep. 13, 2018

(54) ENCRYPTED DATA PACKET

(71) Applicant: Hewlett Packard Enterprise Development LP, Houston, TX (US)

(72) Inventors: Claudio Enrique Viquez Calderon, Heredia (CR); Diego Valverde Garro, San Jose (CR); Jose Daniel Hemandez Vargas, Heredia (CR); Osvaldo Andres Sanchez Melendez, Heredia (CR)

(21) Appl. No.: 15/761,911

(22) PCT Filed: Sep. 22, 2015
(86) PCT No.: PCT/US2015/051379

§ 371 Date: Mar. 21, 2018

(51) Int. Cl. H04L 29/06; H04L 12/715; H04L 12/721

(52) U.S. Cl. CPC H04L 63/0435; H04L 45/38; H04L 45/64; H04L 63/062

(57) ABSTRACT

In example implementations, a method includes a software defined network (SDN) controller that selects an encryption key. The SDN controller then sends a first instruction to a source node to modify a flow table of the source node to include an action that includes the encryption key. A second instruction is sent by the SDN controller to a destination node to modify a flow table of the destination node to include an action that includes the encryption key. The SDN controller can then control a data packet that is encrypted by the source node with the encryption key to be sent from the source node to the destination node, wherein the data packet is to be decrypted with the encryption key by the destination node.

### BACKGROUND

A software defined network (SDN) is an approach to computer networking that allows networks to be managed through higher level abstraction of the network. For example, in an SDN network, the data plane and the control plane are separated. An SDN controller may be used to manage each node in the network and manage the SDN network by controlling data traffic. SDN networks may use communication protocols to allow the control plane to communicate with the data plane.

### BRIEF DESCRIPTION OF THE DRAWINGS

FIG. 1 is a block diagram of an example communication network of the present disclosure;

FIG. 2 is a block diagram of an example node of the present disclosure;

FIG. 3 is a block diagram of an example SDN controller of the present disclosure;

FIG. 4 is a flow diagram of an example method for encrypting a data packet; and

FIG. 5 is a flow diagram of another example method for encrypting a data packet.

### DETAILED DESCRIPTION

The present disclosure broadly discloses a software defined network (SDN) controller that is modified to perform and control data encryption in SDN networks. As discussed above, SDN networks use an SDN controller to separate the data plane and control plane. SDN controllers are currently used to perform routing functions, but do not perform or control encryption functions.

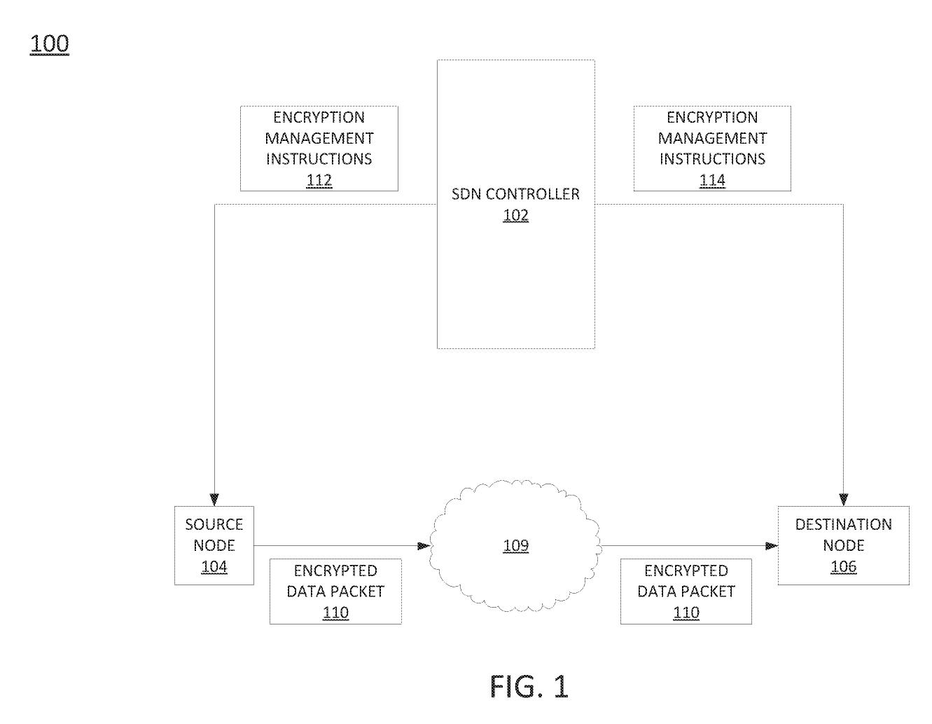

Examples of the present disclosure provide a modification to the SDN controller and nodes in the SDN network to implement encryption management and control by the SDN controller. FIG. 1 illustrates an example SDN network 100. The SDN network 100 may include an SDN controller 102, a source node 104 and a destination node 106. It should be noted that although only a single SDN controller 102, a single source node 104 and a single destination node 106 are illustrated in FIG. 1, any number of SDN controllers, source nodes and destination nodes may be deployed in the SDN network 100. The SDN network 100 may use an Open Flow communication protocol to allow the SDN controller 102, the source node 104 and the destination node 106 to communicate with one another.

In one implementation, the source node 104 may send encrypted data packets 110 over an Internet Protocol (IP) network 109 to the destination node 106. It should be noted that the IP network 109 has been simplified for ease of explanation. For example, the IP network 109 may include additional network elements (e.g., routers, gateways, switches, firewalls, and the like) and access networks (e.g., a broadband access network, a cellular access network, and the like) that are not shown.

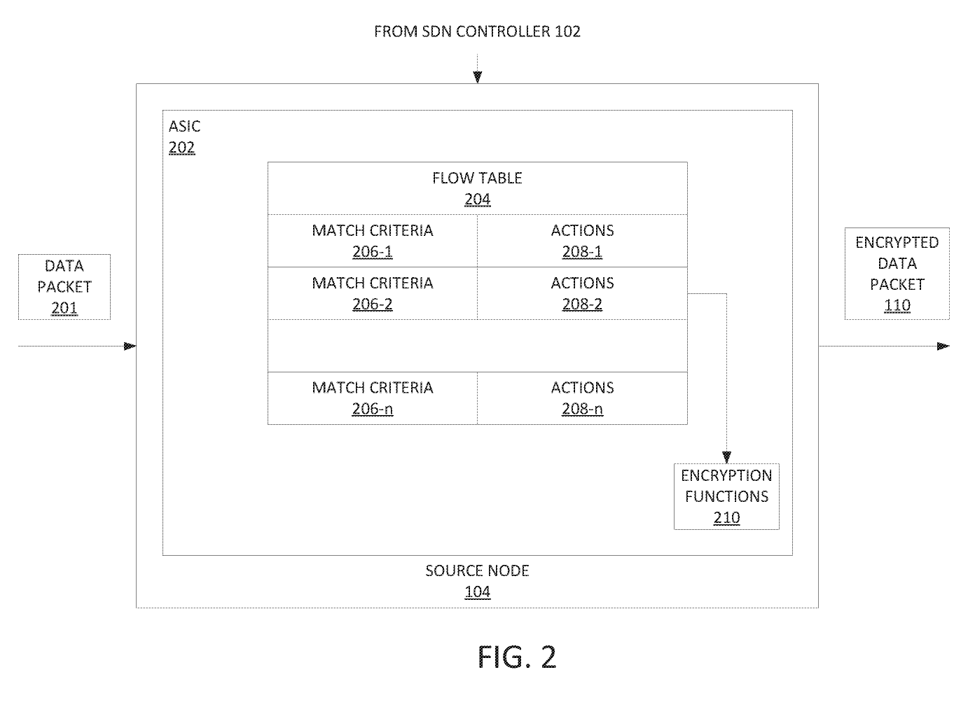

FIG. 2 illustrates a block diagram of an example of the source node 104 of the present disclosure. It should be noted that the destination node 106 may include similar hardware and modifications. The source node 104 may include a processor 202. In one example, the processor may be an application specific integrated circuit (ASIC) 202. The ASIC 202 may include a flow table 204 that is used with Open Flow communication protocol. It should be noted that although the flow table 204 is illustrated as being entirely in the ASIC 202, the flow table 204 may be partially or completely stored in different portions of the SDN network 100 (e.g., the SDN controller 102).

In one example, the flow table 204 may include a plurality of match criteria 206-1 to 206-n (herein after referred to collectively as match criteria 206 or individually as a match criteria 206) and a plurality of actions 208-1 to 208-n (herein after referred to collectively as actions 208 or individually as an action 208). The match criteria 206 may include a tuple that is matched by a tuple of the data packet 201. If the tuple of the match criteria 206 match the tuple of the data packet 201, the action 208 that corresponds with the match criteria 206 may be performed. The tuple may include parameters, such as, a media access control (MAC) address, a source Internet Protocol (IP) address, a destination IP address, or any other parameters that can be found in a header field of the data packet 201.

Typically, the flow table 204 may include match criteria 206 to perform a routing action. However, the present disclosure modifies the flow table 204 to include a new action 208 to perform encryption of a data packet 201.

Referring back to FIG. 1, in one example, the SDN controller 102 may select an encryption key and an encryption function and send a first instruction 112 to the source node 104. The first instruction 112 may be an encryption management instruction that causes the source node 104 to modify the flow table 204 to include the encryption key and the encryption function that is selected in the action 208 associated with a match criteria 206. In other words, the SDN controller sends the actual encryption key that is used and stored in the flow table 204 and an identification of the encryption function that is selected to implement the correct encryption function.

In some implementations, the flow table 204 may include different encryption keys and different encryption functions in different actions 208 for different match criteria 206. For example, match criteria 206-1 may include a first encryption key and first encryption function in the action 208-1 and the match criteria 206-2 may include a second encryption key and a second encryption function in the action 208-2. Thus, the SDN controller 102 may manage and control encryption for a variety of different data packets 201 using a variety of different encryption keys and different encryption functions.

In one example, the source node 104 may also include encryption functions 210. The encryption functions 210 may be implemented as portion, or separate circuit/hardware configuration, in the ASIC 202. The encryption functions 210 may store the methods or techniques to allow the ASIC 202 to perform an encryption on the data packet 201 using the encryption function that is selected by the SDN controller 102 and the encryption key that is sent by the SDN controller 102. In one example, any type of encryption key or encryption function may be used. For example, the encryption functions may include a mask, a rotation, an addition, an XRO, and the like.

The SDN controller 102 may send a second instruction 114 to the destination node 106. The second instruction 114 may be an encryption management instruction that includes the same encryption key and same encryption function as the encryption key and the encryption function that were selected by the SDN controller 102 and sent to the source node 104. The destination node 106 may also be configured similar to the source node 104 illustrated in FIG. 2. In other words, the destination node 106 may also include an ASIC 202 that stores a flow table 204 and has encryption functions 210. The second instruction 114 may cause the destination node 106 to modify its flow table to include a match criteria and action that has the encryption key and the encryption function from the second instruction 114.

Subsequently, when the data packet 201 that matches the match criteria 206 arrives at the source node 104, the source node 104 may encrypt the data packet 201 into an encrypted data packet 110. The encrypted data packet 110 may be sent over the IP network 109 to the destination node 106. The destination node 106 may then match the encrypted data packet 110 to a match criteria in its flow table and decrypt the encrypted data packet 110 with the encryption key sent from the SDN controller 102.

It should be noted that when a plurality of source nodes 104 and a plurality of destination nodes 106 are deployed, that each source node 104 and each destination node 106 may have different match criteria 206 associated with actions 208 that each include different encryption keys and different selected encryption functions in the flow table 204 of each source node 104 and each destination node 106. In other words, the SDN controller 102 has an overview of all the source nodes 104 and destination nodes 106 in the SDN network 100. As a result, the SDN controller 102 may send different encryption keys and select different encryption functions for different match criteria 206 for source nodes 104. Said another way, each flow table 204 of each source node 104 and destination node 106 may not have the same number of encryption keys and encryption functions or the same type of encryption keys and encryption functions.

In other words, the encryption keys and the encryption functions that are selected by the SDN controller 102 can be selectively distributed to source nodes 104 and destination nodes 106 by the SDN controller 102 based upon how data packets 201 are routed within the SDN network 100. As a result, memory space can be saved on the source nodes 104 and the destination nodes 106 as unused encryption methods need not be stored in the encryption functions 210 of respective source nodes 104 and destination nodes 106.

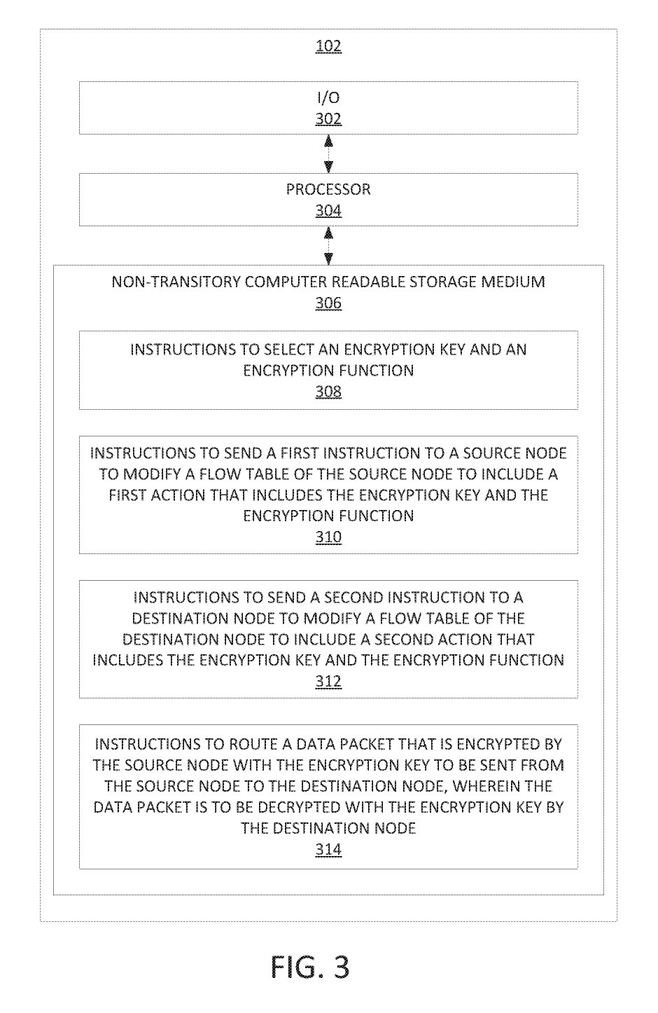

FIG. 3 illustrates a block diagram of an example SDN controller 102 of the present disclosure. In one example, the SDN controller 102 may include an input/output (I/O) interface 302. The I/O interface 302 may allow for connections to external devices (e.g., a monitor, a keyboard, and the like) for programming or configuring parameters of the SDN controller.

In one example, the SDN controller 102 may include a processor 304. The processor 304 may be a central processing unit (CPU), an application specific integrated controller (ASIC), a micro controller, and the like. The processor 304 may be in communication with the I/O interface 302 and a non-transitory computer readable storage medium 306. The processor 304 may execute the instructions stored in the non-transitory computer readable storage medium 306.

In one example, the non-transitory computer readable storage medium 306 may include instructions 308, 310, 312 and 314. The instructions 308 include instructions to select an encryption key and an encryption function. The instructions 310 include instructions to send a first instruction to a source node to modify a flow table of the source node to include an action that includes the encryption key and the encryption function. The instructions 312 include instructions to send a second instruction to a destination node to modify a flow table of the destination node to include an action that includes the encryption key and the encryption function. The instructions 314 include instructions to route a data packet that is encrypted by the source node with the encryption key to be sent from the source node to the destination node, wherein the data packet is decrypted with the encryption key by the destination node.

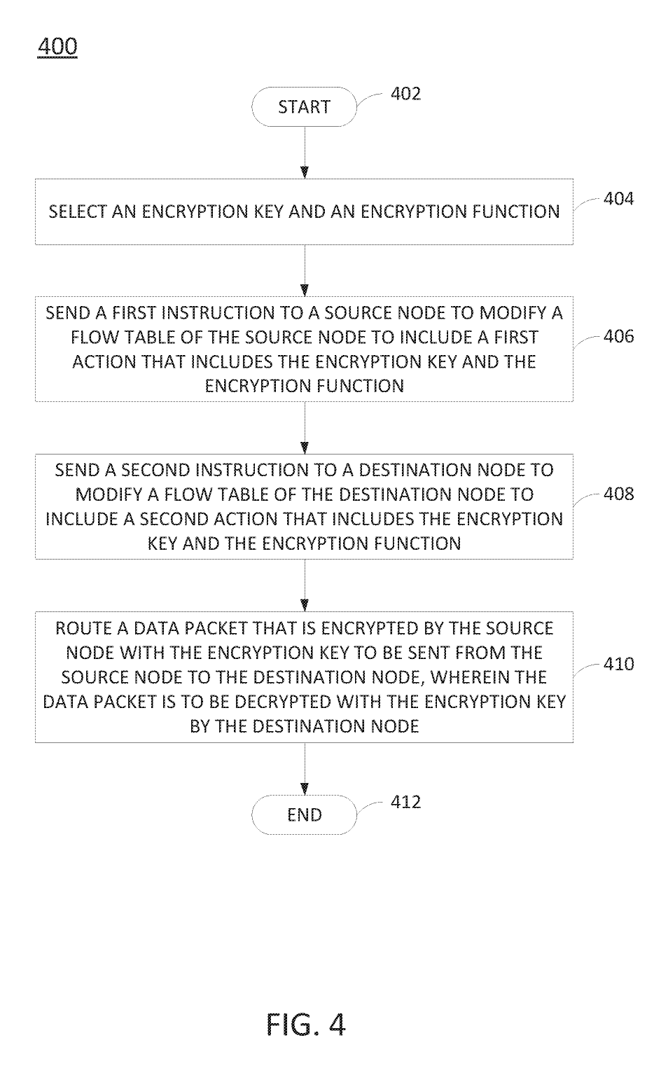

FIG. 4 illustrates a flow diagram of an example method 400 for encrypting a data packet. In one example, the blocks of the method 400 may be performed by the SDN controller 102.

At block 402, the method 402 begins. At block 404, the method 400 selects an encryption key and an encryption function. For example, the encryption key and the encryption function may be selected based on security levels of certain types of data or security levels between certain source node and destination node combinations. For example, certain data packets may have a match criteria and an action having a low level encryption key and a low level encryption function, while more secure data packets may have a match criteria and an action having a high level encryption key and a high level encryption function.

In other implementations, certain customers may pay for a higher level of security. Thus, certain source nodes and/or destination nodes may require a higher level of encryption. The SDN controller 102 may select a strong encryption key and encryption function for those source nodes and destination nodes, while providing a weaker encryption key and encryption function for other source nodes and destination nodes.

At block 406, the method 400 sends a first instruction to a source node to modify a flow table of the source node to include a first action that includes the encryption key and the encryption function. For example, using an Open Flow communication protocol, the SDN controller may send the first instruction to the source node. The source node may modify its flow table in response to the first instruction.

At block 408, the method 400 sends a second instruction to a destination node to modify a flow table of the destination node to include a second action that includes the encryption key and the encryption function. For example, using an Open Flow communication protocol, the SDN controller may send the second instruction to the destination node. The destination node may modify its flow table in response to the second instruction.

At block 410, the method 400 routes a data packet that is encrypted by the source node with the encryption key to be sent from the source node to the destination node, wherein the data packet is to be decrypted with the encryption key by the destination node. For example, a data packet that matches the match criteria for an action that requires encryption may be received by the source node. The SDN controller may manage the routes for data packets. Thus, after the data packet is encrypted, the encrypted data packet may be sent to the destination node as instructed by the flow table in the source node that was configured by routing instructions from the SDN controller. At block 412, the method 400 ends.

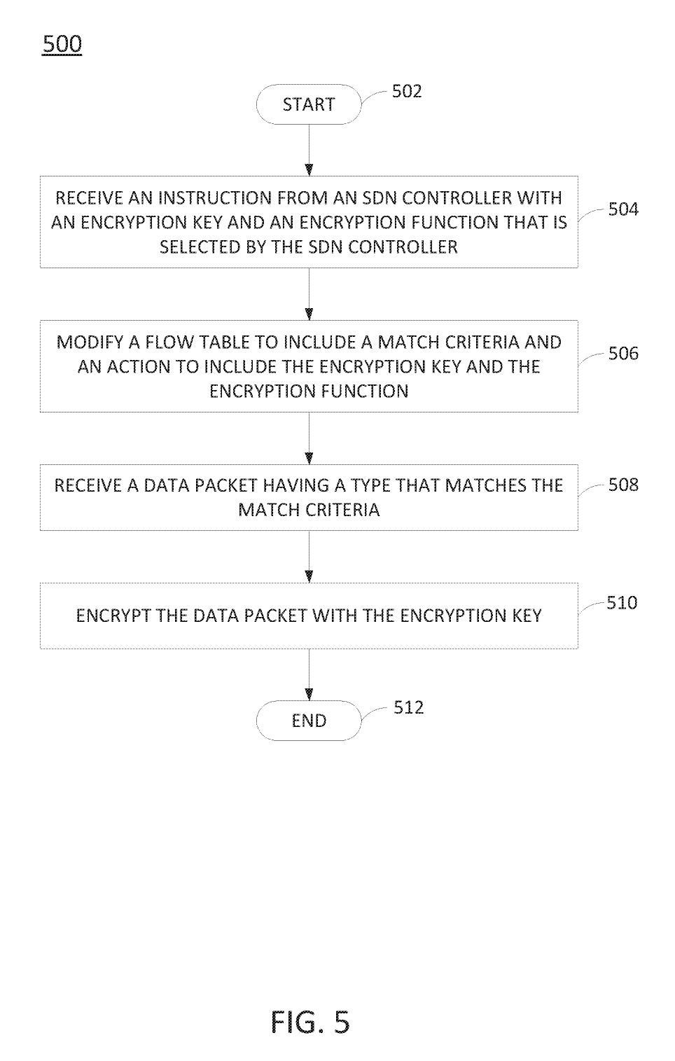

FIG. 5 illustrates a flow diagram of another example method 500 for encrypting a data packet. In one example, the blocks of the method 500 may be performed by the source node 104.

At block 502, the method 500 begins. At block 504, the method 500 receives an instruction from an SDN controller with an encryption key and an encryption function that are selected by the SDN controller. For example, the SDN controller may select an encryption key and an encryption function based on a type of data packet that the source node receives or based on a security level associated with the source node.

At block 506, the method 500 modifies a flow table to include a match criteria and an action to include the encryption key and the encryption function. For example, the match criteria may be added with the parameters provided in the instructions from the SDN controller. The match criteria may include, a MAC address, a source IP address, a destination IP address, or any other parameter that can be found in a header file of the data packet.

The action may include an encryption of the data packet with the encryption key and the encryption function. The encryption key may include, a mask, a rotation, an addition, an XOR, and the like.

At block 508, the method 500 receives a data packet having a tuple that matches the match criteria. For example, the source node may identify the tuple associated with the data packet and compare the tuple to the tuple in the match criteria. If the parameters in the tuple of the data packet match the parameters of the tuple in the match criteria, then the action may be executed.

At block 510, the method 500 encrypts the data packet with the encryption key. In one implementation, the action associated with match criteria may be to encrypt the data packet with the encryption key using the encryption function. Thus, the source node may encrypt the data packet and then transmit the data packet across the IP network to the destination node.

In one example, the destination node may then decrypt the encrypted data packet using the encryption key and the encryption function received from the SDN controller via a second instruction to the destination node. The method 500 may be repeated for each data packet that arrives at the source node. At block 512, the method 500 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
selecting, by a software defined network (SDN) controller, an encryption key and an encryption function;
sending, by the SDN controller, a first instruction to a source node to modify a flow table of the source node to include a first action that includes the encryption key and the encryption function;
sending, by the SDN controller, a second instruction to a destination node to modify a flow table of the destination node to include a second action that includes the encryption key and the encryption function; and
routing, by the SDN controller, a data packet that is encrypted by the source node with the encryption key to be sent from the source node to the destination node, wherein the data packet is to be decrypted with the encryption key by the destination node.

2. (canceled)

3. The method of claim 1, wherein the first action is associated with a match criteria in the flow table of the source node.

4. The method of claim 1, wherein modification of the flow table of the source node causes an encryption functions of the source node to encrypt the data packet in accordance with the encryption function that is selected by the SDN controller using the encryption key sent by the SDN controller.

5. The method of claim 1, wherein the encryption function comprises a mask, a rotation, an addition, or an XOR.

6. An apparatus, comprising:
a processor; and
a non-transitory computer-readable storage medium comprising instructions that, when executed by the processor, cause the processor to:
select an encryption key and an encryption function;
send a first instruction to a source node to modify a flow table of the source node to include a first action that includes the encryption key and the encryption function;
send a second instruction to a destination node to modify a flow table of the destination node to include a second action that includes the encryption key and the encryption function; and
control a data packet that is encrypted by the source node with the encryption key to be sent from the source node to the destination node, wherein the data packet is to be decrypted with the encryption key by the destination node.

7. (canceled)

8. The apparatus of claim 6, wherein the first action is associated with a match criteria in the flow table of the source node.

9. A method, comprising:
receiving an instruction from a software defined network (SDN) controller with an encryption key and an encryption function that are selected by the SDN controller;
modifying a flow table to include a match criteria and an action to include the encryption key and the encryption function;
receiving a data packet having a tuple that matches the match criteria; and
encrypting the data packet with the encryption key.

10. The method of claim 9, wherein the encrypting is performed by an
encryption function.

11. The method of claim 9, wherein the flow table is stored in a programmable networking application specific integrated circuit (ASIC).

12. (canceled)

13. The method of claim 9, wherein the instruction from the SDN controller further comprises parameters for the match criteria.

14. The method of claim 9, wherein the encryption function comprises a mask, a rotation, an addition, or an XOR.

15. The method of claim 9, wherein the data packet that is encrypted is to be decrypted by a destination node with the encryption key sent to the destination node by the SDN controller.

16. The method of claim 3, wherein the data packet includes characteristics which match the match criteria.

17. The apparatus of claim 8, wherein upon arriving at the source node, the data packet is matched to the match criteria prior to being encrypted.

18. The apparatus of claim 17, wherein upon arriving at the destination node, the data packet is matched to match criteria of the destination node prior to being decrypted.

19. The method of claim 9, wherein the tuple includes at least one of: a MAC address, a source IP address, and a destination IP address.

20. The method of claim 9, further comprising transmitting the encrypted data packet across an IP network.

21. The method of claim 21, further comprising receiving another data packet having a tuple that does not match the match criteria and transmitting the other data packet unencrypted across the IP network.

22. The method of claim 3, wherein the match criteria include a tuple that is compared to a corresponding tuple associated with the data packet.

23. The apparatus of claim 8, wherein the match criteria include a tuple that is compared to a corresponding tuple associated with the data packet.
